(19) United States
(12) Patent Application Publication
(10) Pub. No.: US 2006/0068095 A1
(43) Pub. Date: Mar. 30, 2006

(54) Active liquid applicator for forming active film

(75) Inventors: Tsuyoshi Nishi, Osaka (JP); Tomoaki Tsujimoto, Osaka (JP); Akio Harada, Osaka (JP); Kiyomi Kobayashi, Kariya-city (JP); Motoaki Satou, Kariya-city (JP); Namitsugu Fujii, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/273,090

(22) Filed: Nov. 15, 2005

Related U.S. Application Data
(62) Division of application No. 10/292,592, filed on Nov. 13, 2002.

(30) Foreign Application Priority Data
Apr. 17, 2002 (JP) 2002-114213

(51) Int. Cl. B05D 3/12

(52) U.S. Cl. 427/240; 118/254

(57) ABSTRACT

An active liquid applicator is provided which is designed to coat a surface of an electronic parts such as an oxygen sensor with an active liquid for forming an electrode. The liquid applicator includes a nozzle head and a nozzle tube. The nozzle tube has disposed therein a pearmable member which produces capillary attraction of an active liquid thereinto and feed it to the nozzle head, thereby enabling formation of a thin active film on the electronic part which has the thickness controllable with high accuracy.

### CROSS REFERENCE TO RELATED APPLICATION

This application is a Division of application Ser. No. 10/292,592 filed Nov. 13, 2002 the disclosure of which is hereby incorporated by reference in this application.

### BACKGROUND OF THE INVENTION

1. Technical Field of the Invention

The present invention relates generally to an active liquid applicator suitable for coating a surface of an electronic part with an active liquid to form an active film.

2. Background Art

With development of electronic parts technology, electrodes of various electronic parts such as semiconductors have become formed by a noble metal such as platinum. Such electrodes are typically made using a noble metal paste. The noble metal paste is a semi-fluid substance which has viscosity and is formed by dispersing an organic noble metal complex within an organic solvent together with resin.

The formation of a metallic lead and a metallic electrode on the surface of electronic parts is achieved by applying the noble metal paste to a selected area of the electronic parts to form an electrode film and drying and burning it at a given temperature to remove all organic substances therefrom, leaving only metal as a metallic film. As an example of the electronic parts, an oxygen sensor will be described below.

FIG. 15 is a partially cutaway view which shows an oxygen sensor 32 installed in a combustion system of automotive engines. The oxygen sensor 32 is made up of a cup-shaped hollow cylindrical ceramic body 34 made of a solid electrolyte, a reference electrode 36 formed on an inner surface of the ceramic body 34, and a measurement electrode 40 formed on an outer surface of the ceramic body 34. The reference electrode 36 is exposed to a reference gas. The measurement electrode 40 is exposed to a gas to be measured. In order to use terminology in common with typical electronic parts throughout the present specification, the reference electrode and measurement electrode will be referred to as an inner electrode and an outer electrode, respectively. The inner electrode 36 has an inner lead 38.

The oxygen sensor 32 is installed in an exhaust pipe connected to the engine. The outer electrode 40 is exposed to exhaust gasses. The inner electrode 36 is exposed to the air. Between the electrodes 36 and 40, an electric output is produced in proportion to a difference in concentration of oxygen between the exhaust gasses and the air to feed information on excess or lack of oxygen back to a control system. The control system analyzes the information inputted thereto to adjust the quantity of air to be mixed with a fuel gas to an optimum value automatically.

FIG. 20 shows a conventional method of forming the inner electrode 36 within the oxygen sensor 32 using a nozzle tube 42.

The nozzle tube 42 is made of a hollow cylindrical member with a closed end and has installed thereon a hollow cylindrical nozzle head 44 in which outlet holes 46 are formed.

The nozzle tube 42 is inserted into the interior of the ceramic body 34. The nozzle head 44 is held at an interval h away from the inner surface of the ceramic body 34. A noble metal paste is fed to the nozzle tube 42 under a given pressure and emitted from the outlet holes 46. Simultaneously, the ceramic body 34 is turned by one cycle in a direction a, thereby forming a paste-like annular layer 50 having a thickness of h on the inner surface of the ceramic body 34

After the formation of the paste-like annular layer 50, the nozzle tube 42 is withdrawn from the ceramic body 34 to a direction b to form a paste-like lead 52 extending from an edge of the annular layer 50.

The ceramic body 34 is dried and burned at approximately 1000° C., so that all organic substances are removed by heat treatment from the annular layer 50 and the lead 52. Only metallic components are finally left on the inner surface of the ceramic body 34, thereby forming the inner electrode 36 and the lead 38, as shown in FIG. 15.

The performance of the oxygen sensor 32 usually depends upon the compactness and the thickness of the electrodes 36 and 40. After dried and burned, the paste film (i.e., the annular layer 50 and the lead 52) is decreased in thickness. It is, therefore, necessary to determine the thickness h of the paste film which compensates for the decrease in thickness.

An organic solvent contained in the paste usually evaporates while being left as it is. Components of the paste change with time. Thus, even if the paste film has initially a desired thickness, an error in thickness of the electrode 36 and the lead 38 may arise.

The thickness of the paste film depend directly upon the interval h between the nozzle head 44 and the inner surface of the ceramic body 34. Typical adjustment of the interval h is achieved mechanically using the reading on a micrometer and thus quite inconvenient. Further, the amount of the paste supplied to the nozzle tube 42 depends upon the feed pressure and is difficult to adjust.

The paste contains a large quantity of noble metal. If the paste solidifies within the nozzle tube 42 or a dispenser in which the paste is stored, it will cause the noble metal to go to waste. Particularly, if the paste solidifies within the nozzle tube 42, it will be difficult to feed the paste additionally into the nozzle tube 42. In the worst case, it becomes necessary to replace the nozzle tube 42.

### SUMMARY OF THE INVENTION

It is therefore a principal object of the invention to avoid the disadvantages of the prior art.

It is another object of the invention to provide an active liquid applicator designed to coat a surface of an electronic part such as an oxygen sensor with an active liquid to form a thin active film, thereby permitting the active film to be subjected to electroless plating to form a metal film thereon which has the thickness controllable with high accuracy.

According to one aspect of the invention, there is provided an active liquid applicator designed to coat a surface of an electronic part such as an oxygen sensor with an active liquid to form a thin active film for making an electrode or lead wire. The active liquid applicator comprises: (a) dispenser storing therein the active liquid; (b) a nozzle tube connected to the dispenser; (c) a nozzle head provided on an end of the nozzle tube for applying the active liquid on a surface of an electronic part for forming an electrode; (d) a permeable member disposed within the nozzle tube; (e) a first mechanism working to make a contact between the nozzle head and the surface of the electronic part; and (f) a second mechanism working to move the nozzle head and the electronic part relative to each other while keeping the contact therebetween to coat a preselected portion of the surface of the electronic part with the active liquid. The permeable member has a length with first and a second end. The first end is connected to the nozzle head, while the second end is exposed to the active liquid. The permeable member works to feed the active liquid from the dispenser to the nozzle head.

In the preferred mode of the invention, the length of the permeable member is at least five times longer than a diameter of the nozzle tube for ensuring uniformity of the coating on the electronic part.

The dispenser is stood vertically. The permeable member works to produce capillary attraction of the active liquid thereinto to feed the active liquid to the nozzle head for applying the active liquid to the preselected portion of the surface of the electronic part.

The electronic part includes a hollow cylinder. The first mechanism works to place the nozzle head within the hollow cylinder in contact with an inner surface of the hollow cylinder for coating the portion defined on the inner surface of the hollow cylinder with the active liquid.

The electronic parts may be an oxygen sensor including a cup-shaped hollow cylindrical solid electrolyte body which defines a reference gas chamber therein. In this case, the first mechanism works to place the nozzle head within the reference gas chamber in contact with an inner side surface of the solid electrolyte body for coating a portion of the inner side surface with the active liquid to form the electrode on the portion of the inner side surface.

The permeable member is preferably made of one of felt, fiber, and porous material.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a front view which shows an active liquid applicator according to the invention;

FIG. 2 is a longitudinal sectional view which shows a nozzle tube inserted into an electronic part;

FIG. 3 is a longitudinal sectional view which shows a dispenser body in which an active liquid is stored and a nozzle tube connected to the dispenser body;

FIG. 4 is a partially sectional view shows a process of coating an inner peripheral surface of an electronic part 4 with an active liquid emitted from a nozzle head;

FIG. 5 is a sectional view taken along the line A-A in FIG. 4;

FIG. 6 is a partially enlarged view of FIG. 5;

FIG. 7 is a partially sectional view which illustrates a process of forming an active strip film on an inner peripheral surface of an electronic part which works as an electrical lead wire;

FIG. 8 is a partially sectional view which shows a process of coating an inner bottom surface of an electronic part with an active liquid;

FIG. 9 is a partial cutaway view of FIG. 8;

FIG. 10 is a partially sectional view which shows a process of forming an active film on an inner surface of an electronic part with an inner shoulder;

FIG. 11 is a partial cutaway view which illustrates an annular active film and an active strip film formed on an inner surface of an electronic part in the process of FIG. 10;

FIG. 12 is a sectional view which shows a modification of a nozzle head;

FIG. 13 is a sectional view which shows a modification of a permeable member fitted in a nozzle tube;

FIG. 14 is a sectional view which shows the second modification of a permeable member fitted in a nozzle tube;

FIG. 15 is a partially cutaway view illustrating an oxygen sensor to be coated with an active liquid by the active liquid applicator shown in FIG. 1;

FIG. 16 is a perspective view which shows an external appearance of an oxygen sensor;

FIG. 17(a) is a longitudinal sectional view of FIG. 16;

FIG. 17(b) is a longitudinal direction view taken from an angular direction different from that in FIG. 17(a);

FIG. 17(c) is transverse sectional view of FIG. 17(a);

FIG. 18(a) is a longitudinal sectional view which shows a modification of an electrode pattern formed in an oxygen sensor;

FIG. 18(b) is a transverse sectional view of FIG. 18(a);

FIG. 19(a) is a longitudinal sectional view which shows the second modification of an electrode pattern formed in an oxygen sensor;

FIG. 19(b) is a transverse sectional view of FIG. 19(a); and

FIG. 20 is a partially sectional view which shows a ceramic body of an oxygen sensor in which an inner surface is coated with an active paste by a conventional applicator.

### DESCRIPTION OF THE PREFERRED EMBODIMENTS

The inventors of this application studied an improved method of forming an electrode instead of a conventional paste applying method and came to the conclusion that it is the best way to form the electrode using an active film and electroless plating techniques. The inventors made a device, as discussed below, designed to form such an active film.

The active film is a film formed by coating a selected area of a surface of an object on which an electrode is to be formed with an active liquid (i.e., an active catalyst liquid). The active catalyst is an active metal such as platinum. The active liquid is a solution containing a noble metal compound and, for example, prepared by dispersing organic noble metal compounds in an organic solvent.

The active liquid is applied cover a selected portion of a surface of an electronic part to form the active film. After dried, the active film is burned at, for example, 600° C., thereby causing all organic components to be removed from the active film. Thus, resulting in formation of an active metal film. The active metal film has a structure in which active metal nuclei are dispersed like islands. It is advisable that the active metal nuclei be as fine as possible and dispersed to be uniform.

Next, the electronic part on which the active metal film is formed is immersed in an electroless plating liquid. Metal is precipitated on the active metal nuclei, so that the discrete active metal nuclei are joined to each other, thereby forming a thin film. Metal is further precipitated to increase the thickness of the thin film. In this way, the metal is deposited continuously only on the surface of the active metal film. The thickness of the metal film depends upon the metal concentration of the electroless plating liquid, a plating time, and the temperature of the plating bus, et al. The metal film forms an electrode film. The control of thickness of the electrode film may be performed at a stage of the electroless plating. This provides for simple and accurate adjustment of the thickness of the electrode film comparatively.

As apparent from the above discussion, the electrode film is formed only on the active film. The result of formation of the active film and compactness of the active metal film affect the electroless plating performed at a following stage. Specifically, the active film is a prefilm of the electrode film, therefore, a measure of beauty of shape of the prefilm impinges on the configuration of the electrode film. The invention relates to an active liquid applicator used to form the active film, as described above, on an electronic part.

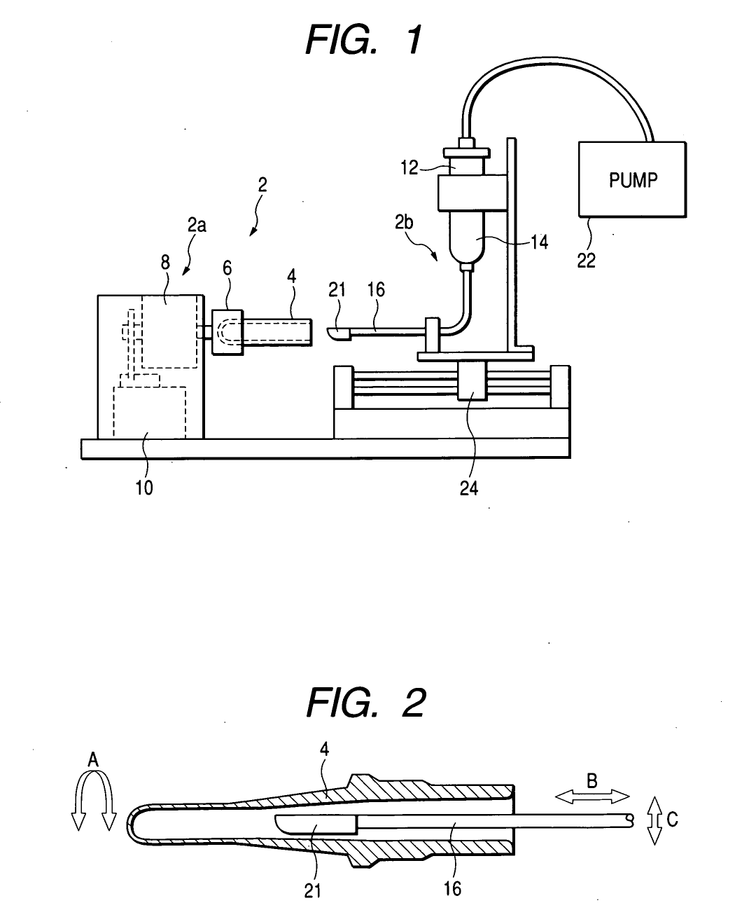

FIG. 1 shows an active liquid applicator 2 according to the invention which is an improvement on a uniformly paste applying device as disclosed in International Patent Publication No. WO99/62644, disclosure of which is incorporated herein by reference.

The active liquid applicator 2 is of a horizontal type in which an electronic parts-holding device 2a and an active liquid dispenser 2b are joined together horizontally. Of course, the device 2a and the dispenser 2b may alternatively be laid vertically. The electronic parts-holding device 2a consists of a parts holder 6, a rotary unit 8, and a height adjuster 10. The parts holder 6 is designed to hold a hollow cylindrical electronic part 4. The rotary unit 8 works to turn the parts holder 6. The height adjuster 10 works to move the rotary unit 8 vertically and holds it at a desired height.

The active liquid dispenser 2b consists of a dispenser body (i.e., a container) 12, a pump 22, a nozzle tube 16, a painting head 21, and a slider 24. The dispenser body 12 stores therein an active liquid 14 which is pressurized and fed by the pump 22 to the nozzle tube 16. The painting head 21 is installed on a tip of the nozzle tube 16 and works to emit the active liquid 14. The slider 24 is designed to move laterally, as viewed in the drawing, to displace the painting head 21 into and out of the electronic part 4.

FIG. 2 is a longitudinal sectional view which shows the electronic part 4, as illustrated as a solid electrolyte body of an oxygen sensor, into which the painting head 21 is inserted. The electronic part 4 is turned in directions A by the rotary unit 8. The electronic part 4 is moved up and down in directions C by the height adjuster 10. The painting head 21 and the nozzle tube 16 are moved horizontally in directions B by the slider 24. These movements may be achieved simultaneously or separately.

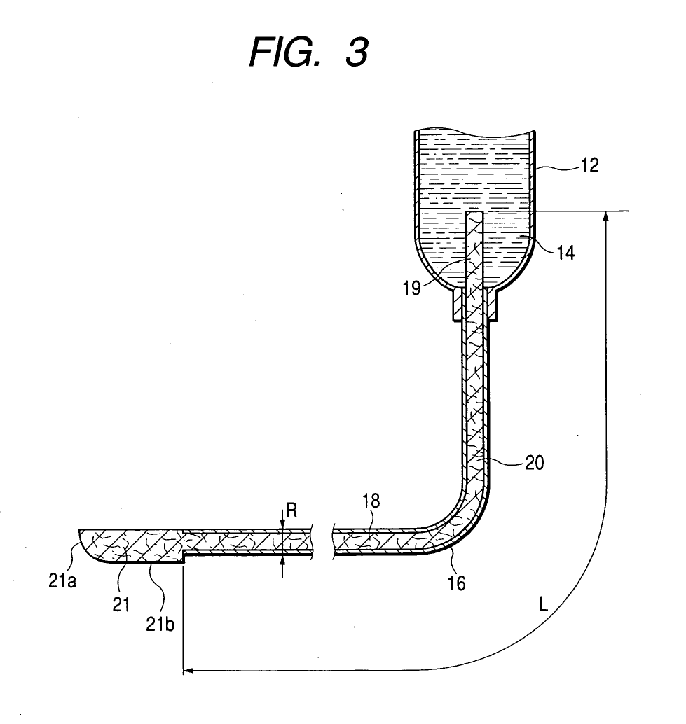

FIG. 3 is a longitudinal sectional view which shows the dispenser body 12, the nozzle tube 16, and the painting head 21 of the active liquid dispenser 2b. Within the dispenser body 12, the active liquid 14 is stored. The nozzle tube 16 is bent to an L-shape and joined to the bottom of the dispenser body 12. Within the nozzle tube 16, a permeable member 18 is disposed which is made of an osmotic material working as a capillary tube to produce capillary attraction of the active liquid 14 thereinto and feed it to the painting head 21. Specifically, the permeable member 18 consist of a liquid sucking end 19, a liquid feeding tube 20, and the painting head 21. The liquid sucking end 19 is inserted into the dispenser body 12 and works to suck in the active liquid 14. The liquid feeding tube 20 works to feed the active liquid 14 through the capillarity. The painting head 21 emits the active liquid 14 fed from the liquid feeding tube 20.

The liquid sucking end 19 of the permeable member 20 is illustrated as extending into the dispenser body 12, but may be located inside the nozzle tube 16. Specifically, the length L of a permeable portion of the permeable member 18 (i.e., the distance between the liquid sucking end 19 and a downstream end of the permeable member 18) may be either greater (i.e., L>Ln) or smaller (i.e., 0<L≦Ln) than the length Ln of the nozzle tube 16. When L≦Ln, the active liquid 14 is also stored within the nozzle tube 16, but sucked by the liquid sucking end 19 into the liquid feeding tube 20 sufficiently. If the inner diameter of the nozzle tube 16 (i.e., the diameter of an inner wall of the nozzle tube 16) is defined as R, the seepage force or capillary attraction of the active liquid 14 into the permeable member 18 depends upon L/R.

The permeable member 18 may be, as described above, made of any material exhibiting the capillarity action. A permeable material typically used as a tip of a marking pen is preferable. For example, a soft felt pen material made of wool, synthetic fiber, and thermally weldable fiber, a similar material to which resin is also added for improving the durability thereof, a synthetic fiber material formed by bonding synthetic fibers made of acrylic, polyester, and nylon using resin to increase the mechanical strength thereof, or other fiber pen materials may be employed. Further, a plastic pen material may also be employed which has formed therein interconnecting holes producing capillary attraction of the active liquid 14 thereinto. For example, copolymer or homopolymer such as polyacetal resin having formed therein many interconnecting cavities exhibiting the capillary action may be used. A porous material such as sponge may also be used.

The painting head 21 of the permeable member 18 is shaped like a pen tip suitable for applying the active liquid 14 to the surface of the electronic part 4. The painting head 21 has a curved portion 21a and a straight portion 21b. The curved portion 21a is shaped for coating a curved wall (i.e. the bottom) of the electronic part 4 with the active liquid 14. The straight portion 21b is shaped for coating a straight wall (i.e., an inner side wall) of the electronic part 4 with the active liquid 14.

The installation of the permeable member 18 in the nozzle tube 16 is achieved by inserting the permeable member 18 into the nozzle tube 16 extending straight and bending the nozzle tube 16 to the L-shape.

The active liquid 21 is liquid having a low viscosity which is made of a metal compound containing an active metal such as platinum. The active liquid 21 may be made by dispersing a metal organic compound such as platinum balsam sulfide or a metal inorganic compound such as platinum chloride in an organic solvent.

The inventors of this application have proposed in Japanese Patent First Publication No. 9-272996 an active liquid made by dispersing a noble metal organic complex such as bis(dibenzylideneacetone) noble metal or tris(dibenzylideneaceton) noble metal in an organic solvent, which may be used as the active liquid 21. Disclosure of the publication is incorporated herein by reference.

The active liquid 14, unlike paste, has a lower viscosity and capable of burbling, so that it is less susceptible to solidification within the dispenser body 12 as well as the permeable member 18. This enables a desired amount of the active liquid 14 to be emitted from the painting head 21 at all times.

The paste, as described in the introductory part of this application, is apt to solidify within the dispenser body 12 or adhere to other parts, so that the noble metal contained in the paste runs to waste as well as the paste itself. The active liquid 14 used in this embodiment is less susceptible to solidification within the dispenser body 12 and adhesion to other parts, thus eliminating the above problem.

The painting head 21 is always wet with the active liquid 14 by the capillary action thereof, but it is difficult to supply a required amount of the active liquid 14 to the painting head 21 at all times only by the capillary attraction developed by the permeable member 18. Thus, when it is required to emit an amount of the active liquid 14 from the painting head 21 exceeding the limit of the capillary attraction, the pump 22 is turned on to feed the active liquid 14 to the painting head 21 under a set pressure.

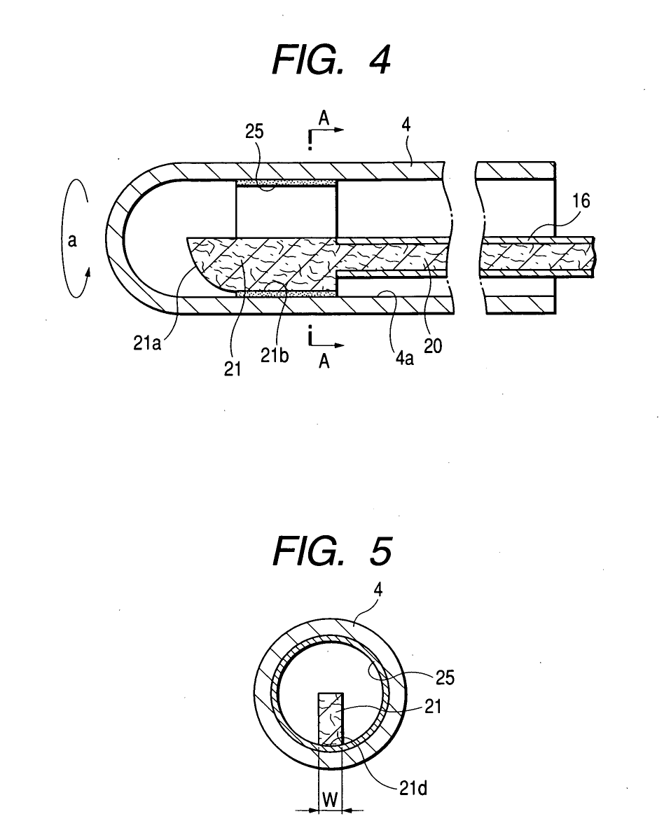

FIG. 4 shows a process of coating an inner side surface 4a of the electronic part 4 with the active liquid 14.

First, the height adjuster 10 adjusts the height of the electronic part 4 to place the straight portion 21b of the painting head 21 in contact with the inner side surface 4a of the electronic part 4. Next, the slider 24 is actuated to advance the painting head 21 to a required location within the electronic part 4.

When the straight portion 21b of the painting head 21 is placed in contact with the inner side surface 4a of the electronic part 4, it will cause the active liquid 14 to be transferred from the painting head 21 to the inner side surface 4a to form a thin coat of the active liquid 14 on the inner side surface 4a. The rotary unit 8 turns the electronic part 4 one cycle in a direction a while keeping the positional relation between the painting head 21 and the electronic part 4 as it is, thereby forming an annular active film 25 over 360° on the inner side surface 4a.

FIG. 5 is a sectional view taken along the line A-A in FIG. 4. If the width of the painting head 21 is defined as W, and the width of the coat of the active liquid 14 on the inner side surface 4a is defined as w, then a condition of W≦w is usually met. The greater the permeability of the active liquid 14, the greater the width w of the coat of the active liquid 14 than the width W of the painting head 21. It is, thus, possible to estimate a coating efficiency as a function of a difference between w and W. We performed tests, as described later, using several samples to measure the difference w and W and determined that when the value of w−W is 2 mm or less, a coating condition is acceptable (◯), and when it is more than 2 mm, the coating condition is unacceptable (X).

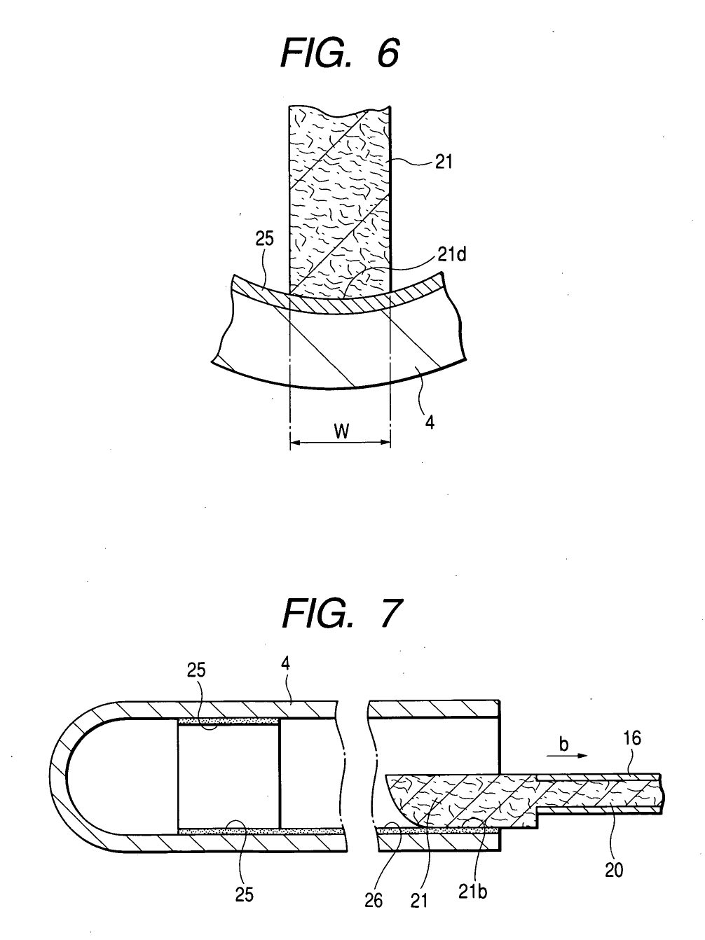

FIG. 6 is a partially enlarged view of FIG. 5. It is advisable that the painting head 21 be placed substantially in contact with the electronic part 4, and the radius of curvature of an outer surface 21d of the painting head 21 be substantially equal to that of the inner side surface 4a of the electronic part 4. However, if it is possible to keep a clearance between the outer surface 21d of the painting head 21 and the inner side surface 4a of the electronic part 4 very small, the outer surface 21d of the painting head 21 needs not always be curved.

FIG. 7 illustrates a process of forming an active linear film on the inner side surface of the electronic part 4 which works as an electrical lead.

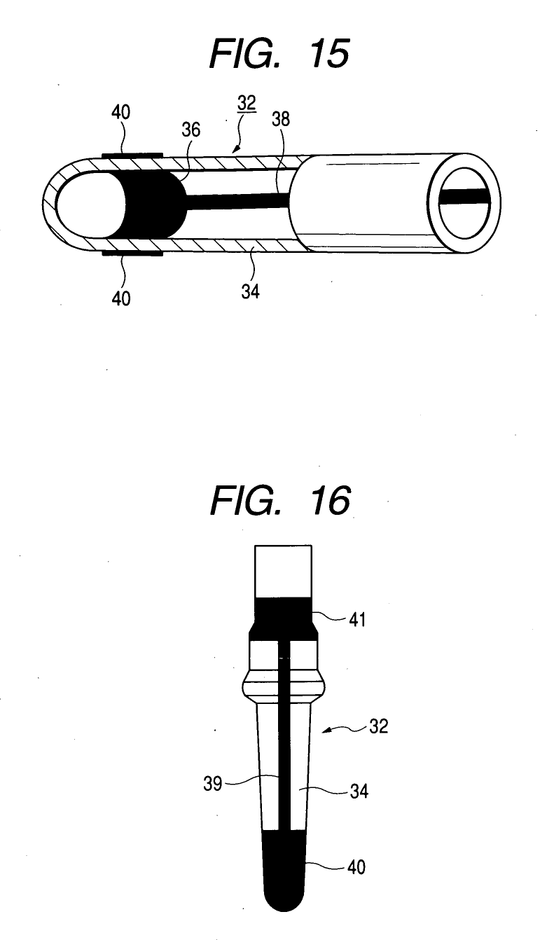

The painting head 21 is withdrawn by the slider 24 straight from a position, as illustrated in FIG. 4, in a direction b, thereby forming the active strip film 26 on the inner side surface of the electronic part 4 which extends from an edge of the annular active film 25. The active strip film 26 has the width w which is defined as a function of the width W of the painting head 21. Finally, the annular active film 25 and the active strip film 26 are subjected to the electroless plating to complete the inner electrode 36 and the inner electrode lead 38, as shown in FIG. 15.

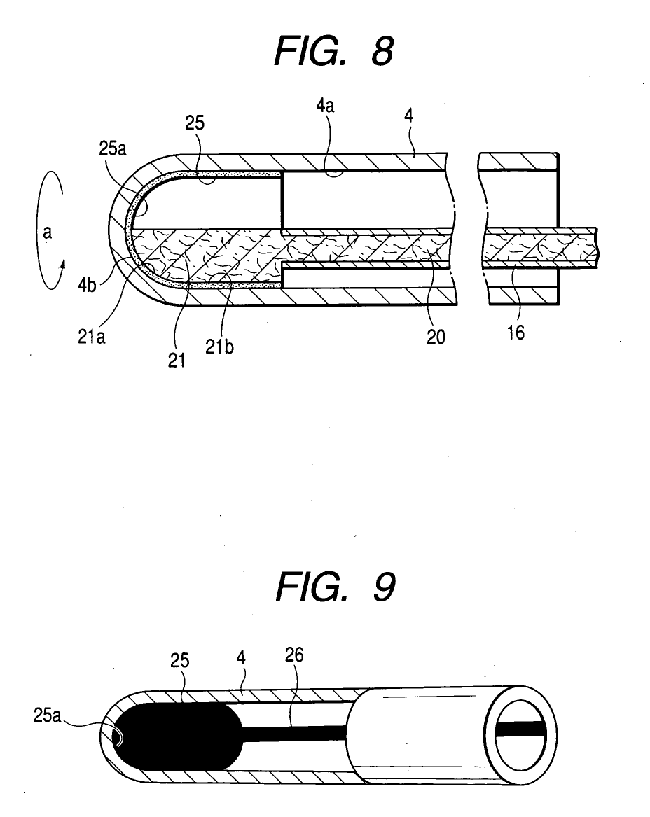

FIG. 8 shows a process of coating an inner bottom surface 4b of the electronic part 4 with the active liquid 14. In a case where the electronic part 4 is used as an oxygen sensor, the inner electrode which covers the inner bottom surface 4b is preferably formed in terms of a sensing efficiency. In this embodiment, the curved portion 21a of the painting head 21 is contoured to conform with the contour of the inner bottom surface 4b of the electronic part 4.

First, the inner side surface 4a of the electronic part 4 is brought into contact with the straight portion 21b of the painting head 21. The painting head 21 is advanced by the slider 24 until it reaches the inner bottom surface 4b. Next, the electronic part 4 is rotated one cycle in the direction a to coat the inner bottom surface 4b with the active liquid 14, thereby forming a single cup-shaped active film which includes the annular active film 25 identical with the one shown in FIG. 4 and an active bottom film 25a. Subsequently, the painting head 21 is withdrawn by the slider 24 straight to form an active strip film identical with the strip 26 in FIG. 7.

FIG. 9 is a partial cutaway view of FIG. 8 which illustrates the annular active film 25, the active bottom film 25a, and the active strip film 26 formed on the inner surface of the electronic part 4.

After dried, the illustrated electronic part 4 is burned at 400 to 600° C. to remove organic substances from the films 25, 25a and 16, thereby forming an active metal film. The active metal film is subjected to the electroless plating using, for example, platinum to form an inner electrode with a lead within the electronic part 4.

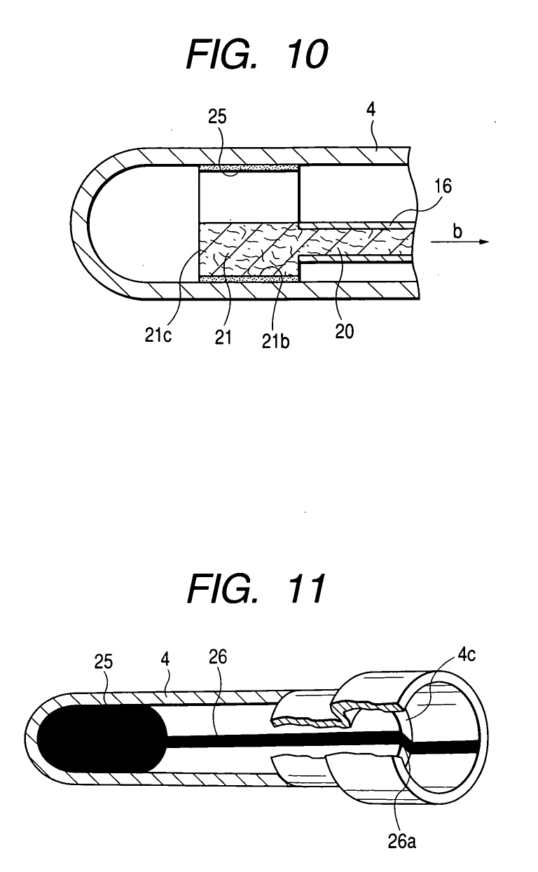

FIG. 10 shows a process of forming an active film on an inner surface of an electronic part 4 with an inner shoulder. The nozzle head 2 used in this process has a flat end 21c extending perpendicular to the length of the nozzle tube 16 instead of the curved portion 21a.

First, the inner side surface 4a of the electronic part 4 is, like the above, brought into contact with the straight portion 21b of the painting head 21. Next, the electronic part 4 is rotated one cycle in the direction a to coat the inner side surface 4a with the active liquid 14, thereby forming the annular active film 25. Subsequently, the painting head 21 is withdrawn by the slider 24 in the direction b.

FIG. 11 is a partial cutaway view which illustrates the annular active film 25 and the active strip film 26 formed on the inner surface of the electronic part 4 in the process of FIG. 10. After the annular active film 25 is formed, the painting head 21 is, as described above, withdrawn. When the flat end 21c of the painting head 21 reaches above the inner shoulder 26a, the electronic part 4 is lifted up by the height adjuster 10 to have the flat end 21c slide on the inner shoulder 26a, thereby forming a vertical active strip film 26a that is a portion of the active strip film 26. Subsequently, the painting head 21 is further withdrawn to complete the active strip film 26. Specifically, the active film made up of the annular active film 25 and the active strip film 26 including the vertical active strip film 26a is formed on the inner side surface 4a of the electronic part 4.

After dried, the electronic part 4 is burned at 400 to 600° C. to remove organic substances from the films 25 and 16, thereby forming an active metal film. The active metal film is subjected to the electroless plating using, for example, platinum to form an inner electrode with a lead within the electronic part 4.

The active metal film is, as described above, the prefilm made only by an active metal and has preferably a thickness of, for example, about 1 μm. After formation of the active metal film, the electronic part 4 is immersed in an electroless plating bus to precipitate the active metal on the active metal film, thereby forming the electrode film. Adjustment of the thickness of the electrode film may be accomplished by controlling the concentration and temperature of an electroless plating liquid and a plating time.

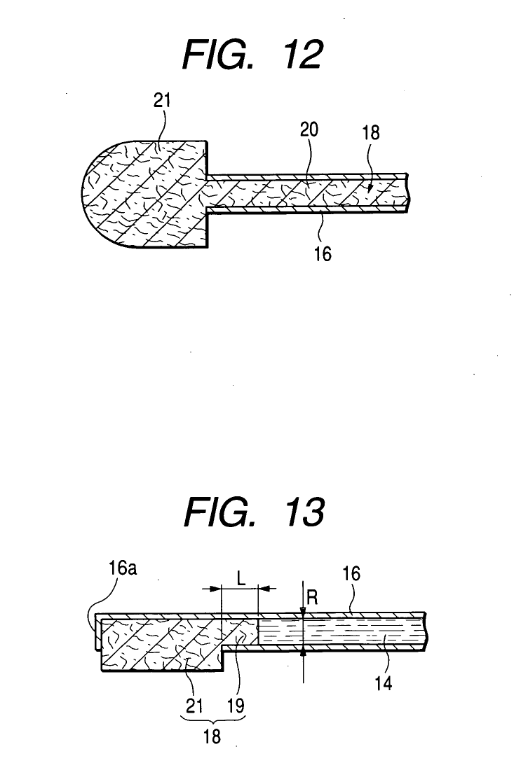

FIG. 12 is a sectional view which shows a modification of the painting head 21. The painting head 21 has a domed tip which is slightly smaller in size than the inner bottom surface 4b of the electronic part 4. The domed tip of the painting head 21 is less susceptible to deformation when the painting head 21 collides with any object during operation of the active liquid applicator 2 and exhibits a required degree of durability. The active bottom film 25a and the annular active film 25 are formed simultaneously by placing the domed tip of the painting head 21 in contact with the inner bottom surface 4b of the electronic part 4 and turning the electronic part 4 one cycle.

FIG. 13 is a sectional view which shows a modification of the permeable member 18 which is much shorter than the one shown in FIG. 3. Specifically, the liquid sucking end 19 of the permeable member 18 is located within the nozzle tube 16 and also works as the liquid feeding tube 20 as shown in FIG. 3. The nozzle tube 16 has a nozzle holder 16a which avoids dislodgement of the permeable member 18 (i.e., the painting head 21) from the nozzle tube 16. The active liquid 14 is in the vicinity of the tip of the nozzle tube 16 and permeates the painting head 21 through the liquid sucking end 19.

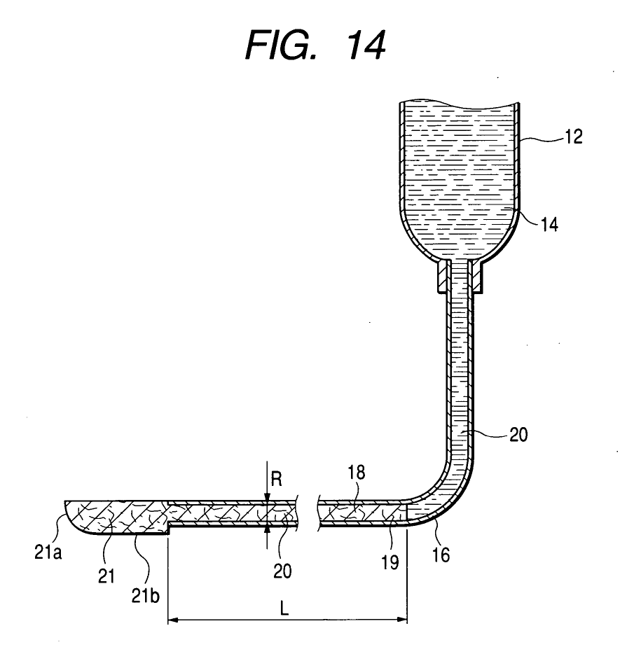

FIG. 14 is a sectional view which shows the second modification of the permeable member 18. The liquid sucking end 19 of the permeable member 18 is located at the middle of the nozzle tube 16.

We performed tests using samples of the permeable member 18 to evaluate conditions of coatings of the active liquid 14 on the electronic part 4 for different values of the length L of the permeable member 18 and the inner diameter R of the nozzle tube 16, and different materials of the permeable member 18. As already described above, when the difference between the width W of the painting head 21 and the width w of the coating of the active liquid 14; namely, w−W is 2 mm or less, the coating condition is determined as being acceptable (◯), and when it is more than 2 mm, the coating condition is determined as being unacceptable (X). The results of the tests are shown in the following table.

TABLE

| | | | | Perme- | | |
|---|---|---|---|---|---|---|
| | | | | able | Liquid feed | Coating |
| Test No. | R (mm) | L (mm) | L/R | material | pressure | condition |
| 1 | 0.5 | 0 | — | felt | not used | X |
| 2 | 0.5 | 5 | 10.0 | felt | not used | ◯ |
| 3 | 0.5 | 100 | 200.0 | felt | not used | ◯ |
| 4 | 1 | 0 | — | felt | not used | X |
| 5 | 1 | 15 | 15.0 | felt | not used | ◯ |
| 6 | 1 | 50 | 50.0 | felt | not used | ◯ |
| 7 | 1 | 200 | 200.0 | felt | not used | ◯ |
| 8 | 1.5 | 0 | — | felt | not used | X |
| 9 | 1.5 | 1.5 | 1.0 | felt | not used | X |
| 10 | 1.5 | 7.5 | 5.0 | felt | not used | ◯ |
| 11 | 1.5 | 10 | 6.7 | felt | not used | ◯ |
| 12 | 1.5 | 15 | 10.0 | felt | not used | ◯ |
| 13 | 1.5 | 30 | 20.0 | felt | not used | ◯ |
| 14 | 1.5 | 50 | 33.3 | felt | not used | ◯ |
| 15 | 1.5 | 100 | 66.7 | felt | not used | ◯ |
| 16 | 1.5 | 200 | 133.3 | felt | not used | ◯ |
| 17 | 1.5 | 400 | 266.7 | felt | used | ◯ |
| 18 | 1.5 | 400 | 266.7 | felt | not used | ◯ |
| 19 | 2 | 10 | 5.0 | felt | not used | ◯ |
| 20 | 2 | 50 | 25.0 | felt | not used | ◯ |
| 21 | 2 | 400 | 200.0 | felt | not used | ◯ |
| 22 | 2.5 | 50 | 20.0 | felt | not used | ◯ |
| 23 | 3 | 300 | 100.0 | felt | not used | ◯ |
| 24 | 1.5 | 10 | 6.7 | fiber | not used | ◯ |
| 25 | 1.5 | 30 | 20.0 | fiber | not used | ◯ |
| 26 | 1.5 | 200 | 133.3 | fiber | not used | ◯ |
| 27 | 1.5 | 30 | 20.0 | porous | not used | ◯ |
| | | | | rub. | | |
| 28 | 1.5 | 200 | 133.3 | porous | not used | ◯ |
| | | | | rub. | | |
| 29 | 1.5 | 200 | 133.3 | porous | used | ◯ |
| | | | | rub. | | |
| 30 | 1.5 | 400 | 266.7 | porous | used | ◯ |
| | | | | rub. | | |

The table shows that the coating condition changes depending upon of a ratio of the length L of the permeable member 18 to the inner diameter R of the nozzle tube 16; namely L/R. We found that the coatings of the active liquid 14 on the electronic part 4 are acceptable when L/R is preferably more than or equal to five (5), and more preferably more than or equal to ten (10), and that the active liquid 14 has a lower viscosity so that it may easily permeate the permeable member 18, thereby resulting in a difficulty in controlling the amount of the active liquid 14 outputted from the painting head 21, which may lead to irregularity of the coatings when L/R is less than five (5).

Even if L/R<5, it is possible to increase the viscosity of the active liquid 14 and feed the active liquid 14 under pressure, but if the length L of the permeable member 18 is smaller, a difficulty is encountered in controlling the level of the pressure, thus requiring an expensive pressure controller. Alternatively, if L/R is greater such as in the test No. 18 in the above table, it results in lack of applied amount of the active liquid 14, which may lead to formation of blurs on the coatings. In this case, it is preferable to feed the active liquid 14 under pressure. The permeable member 18 in the test Nos. 29 and 30 is made of porous rubber which is somewhat less in pore than felt. It is, thus, preferable to feed the active liquid 14 under pressure.

FIG. 15 is, as already described, a partially cutaway view illustrating the oxygen sensor 32 installed in a combustion system of automotive engines. The oxygen sensor 32 is made up of the cup-shaped hollow cylindrical ceramic body 34 made of a solid electrolyte, the inner electrode 36, and the outer electrode 40. The inner electrode 36 connects with the inner lead 38 which is to be joined to an external circuit (not shown).

In order to form the outer electrode 40, a selected area of the outer wall of the ceramic body 34 is first coated in a desired outer electrode pattern with an active paste by transfer techniques employing a rolled pad. The active paste contains a noble metal compound for forming a noble metal nucleus. The coating on the ceramic body 34 is heated to dry organic solvent contained in the active paste.

Subsequently, the formation of the inner electrode 36 is achieved using the active liquid applicator 2 as shown in FIGS. 1 and 3. First, the active liquid 14 containing a noble metal compound is applied to the inner surface of the ceramic body 34 in a desired inner electrode pattern and heated to dry the organic solvent. The ceramic body 34 is further heated at 400 to 600° C. to remove a binder contained in the coating and decompose the noble metal compound to form a noble metal nucleus on the coating. This burning also servers to remove the organic solvent from the coating on the outer wall of the ceramic body 34, thereby completing the outer electrode 40.

Finally, the noble metal nucleus formed on the inner wall of the ceramic body 34 is subjected to the electroless plating to complete the inner electrode 36. The noble metal nucleus and the plated coating are preferably made of platinum, but may be made of Pd, Au, or Rh. Of course, the noble metal nucleus and the plated coating may be made different materials.

FIG. 16 shows a modification of the oxygen sensor 32. The outer electrode 40 is a gas measurement electrode which is exposed to exhaust emissions of an automotive engine and works to output a signal to an external circuit through the outer lead 39. Examples of the oxygen sensor 32, as will be discussed below, are all identical in external appearance with the one shown in FIG. 16.

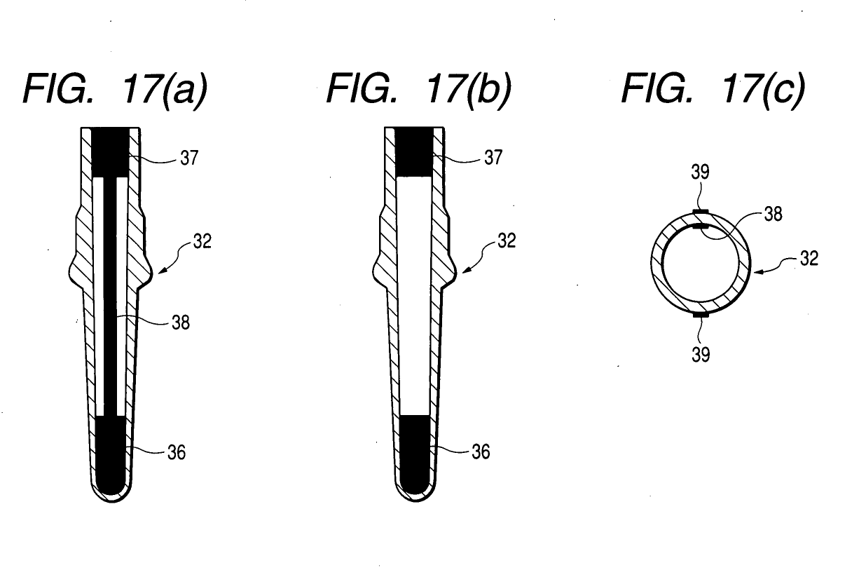

FIGS. 17(a) to 17(c) show an electrode pattern which may be formed within in the oxygen sensor of FIG. 16. FIG. 17(a) is a longitudinal sectional view of FIG. 16 and illustrates the inner electrode 36 joined to an inner electrical terminal 37 through the inner lead 38. FIG. 17(b) is a longitudinal sectional view of FIG. 16 as taken from an angular direction different from that in FIG. 17(a) in which the inner lead 38 is invisible. FIG. 17(c) is a transverse sectional view which show the two outer leads 39 and the single inner lead 38 are formed on the outer and inner walls of the oxygen sensor 32.

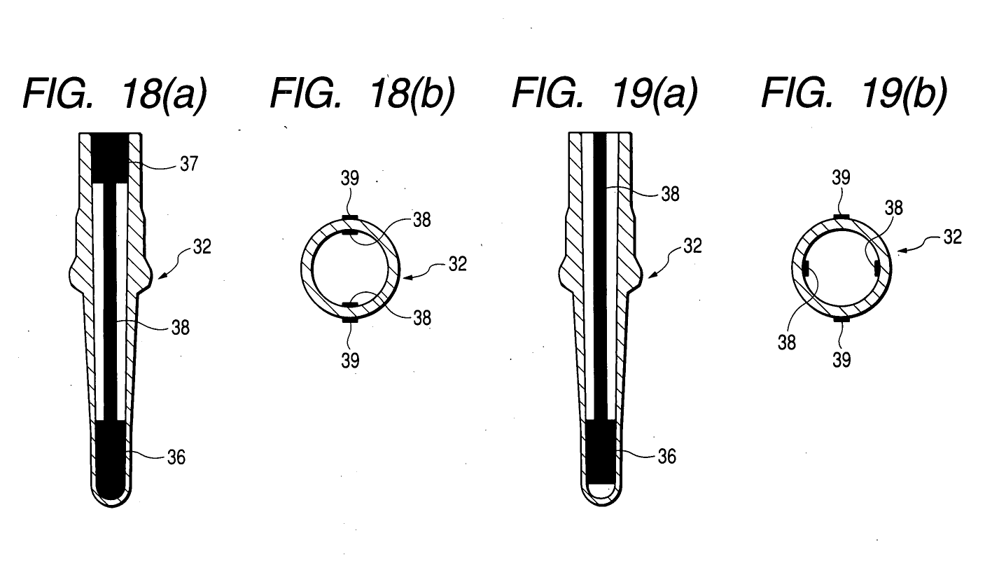

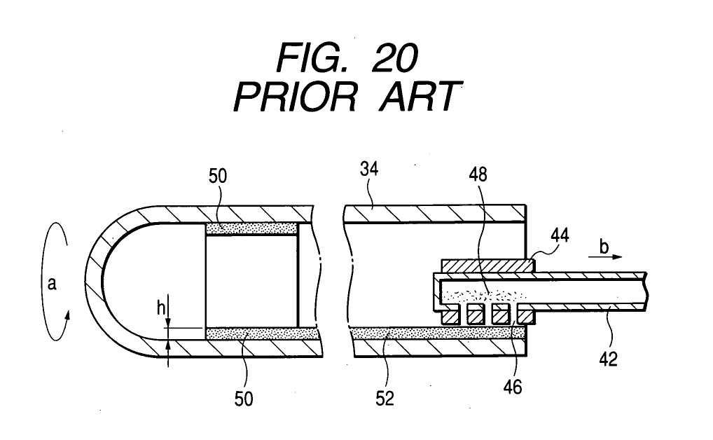

FIGS. 18(a) and 18(b) show a modification of the oxygen sensor 32. Two inner leads 38 are, as clearly shown in FIG. 18(b), formed on the inner wall of the oxygen sensor 32.

FIGS. 19(a) and 19(b) show the second modification of the oxygen sensor 32. The inner leads 38 are shifted 90° from the outer leads 39 in a circumferential direction of the oxygen sensor 32. The inner electrical terminal 37 is not formed. An upper end, as viewed in FIG. 19(a), of each of the inner leads 38 works as an electrical terminal.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For example, the active liquid applicator 2 may be of a vertical type in which the active liquid dispenser 2b is laid on the electronic parts-holding device 2a vertically. In this case, the electronic part 4 is stood vertically with an opening thereof oriented upward. The nozzle tube 16 is suspended vertically from the dispensor body 14 with the painting head 21 oriented downward. The slider 24 works to move the nozzle tube 16 vertically to insert the painting head 21 into the electronic part 4. The rotary unit 8 turns the electronic part 4 to coat the inner wall of the electronic part 4 with the active liquid 14. The vertical movement of the nozzle tube 16 and the rotational movement of the electronic part 4 form the annular active film 25 and the active strip film 26 on the inner wall of the electronic part 4.

The active liquid dispenser 2b and the electronic parts-holding device 2a may alternatively be disposed diagonally. In this case, the active liquid dispenser 2b is located preferably above the electronic parts-holding device 2a because the painting head 21 is well wet with the active liquid 14 with aid of the capillary action of the permeable member 18, but a positional relation between the active liquid dispenser 2b and the electronic parts-holding device 2a may be changed as required.

What is claimed is:

1. A method of forming a thin active film within the reference gas chamber of an oxygen sensor including a cup-shaped hollow cylindrical solid electrolyte body which defines said reference gas chamber, the method comprising:
providing a nozzle tube having a nozzle head provided on one end thereof and connected to a dispenser storing therein an active liquid, a permeable member being disposed within said nozzle tube and having a length with first and second ends, the first end being connected to the nozzle head and the second end being exposed to the active liquid, said permeable member working to feed the active liquid from said dispenser to said nozzle head;
providing an oxygen sensor including a cup-shaped hollow cylindrical solid electrolyte body which defines a reference gas chamber therein;
placing the nozzle head within the reference gas chamber and in contact with an inner side surface of the solid electrolyte body;
moving at least one of said nozzle head and said oxygen sensor relative to each other while maintaining said contact therebetween to coat a preselected portion of said inner side surface of the solid electrolyte body with the active liquid.

2. A method as in claim 1, wherein said moving comprises rotating said cup-shaped hollow cylindrical solid electrolyte body about a longitudinal axis thereof so as to coat an annular band portion of the inner side surface of the solid electrolyte body with said active liquid.

3. A method as in claim 2, wherein said moving comprises moving said nozzle head longitudinally with respect to the cup-shaped hollow cylindrical solid electrolyte body thereby to define a longitudinal band extending from said (at least part) annular band portion.
